(19) United States
(12) Patent Application Publication
(10) Pub. No.: US 2013/0290206 A1
(43) Pub. Date: Oct. 31, 2013

(54) METHOD AND APPARATUS FOR ELECTRONIC JOB RECRUITING

(71) Applicants: Sheeroy DESAI, San Francisco, CA (US); Luca BONMASSAR, Marina di Massa (IT)

(72) Inventors: Sheeroy DESAI, San Francisco, CA (US); Luca BONMASSAR, Marina di Massa (IT)

(73) Assignee: GILD, INC., San Francisco, CA (US)

(21) Appl. No.: 13/568,493

(22) Filed: Aug. 7, 2012

Related U.S. Application Data
(63) Continuation-in-part of application No. 13/493,791, filed on Jun. 11, 2012.
(60) Provisional application No. 61/640,656, filed on Apr. 30, 2012.

(51) Int. Cl. G06Q 10/06

(52) U.S. Cl. 705/321

(57) ABSTRACT

A recruitment enhancement system is disclosed that can be used by job recruiters to assess job applicant's suitability for particular jobs. The recruitment enhancement system can maintain and regularly update a proprietary database of individuals where the individuals can be scored or ranked within a profession. The recruitment enhancement system can be configured to receive a recruitment service request including one or more individuals. In response to receiving the request, the system can attempt to match the one or more individuals named in the request to individuals maintained in the proprietary database. Scores or ranks for the matched individuals can be returned in a response to the request.

### CROSS REFERENCE TO RELATED APPLICATIONS

The present application is a continuation-in-part and claims priority to U.S. patent application Ser. No. 13/493,791, entitled “RECRUITING SERVICE GRAPHICAL USER INTERFACE”, filed Jun. 11, 2012, by Bonmassar et al., which claims the benefit of U.S. Provisional Application No. 61/640,656, filed Apr. 30, 2012, entitled “RECRUITING SERVICE GRAPHICAL USER INTERFACE”, the contents of each of which are hereby incorporated by reference in their entirety and for all purposes.

### FIELD OF THE INVENTION

The present invention is generally related to employment recruitment tools. More particularly, the present invention is directed to providing recruitment services, such as ranking job recruits in an applicant tracking system.

### BACKGROUND OF THE INVENTION

An applicant tracking system is a software application that enables the electronic handling of recruitment needs. Nearly all major corporations use some form of applicant tracking system to handle job applications and to manage resume data. The principal function of an applicant tracking system is to provide a central location and database for a company's recruitment efforts. Applicant tracking systems are built to better assist management of resumes and applicant information. Data can either be collected from internal applications via the applicant tracking system's front-end, located on the company website or can be extracted from applicants on job boards.

Not long ago, job applicants often learned of available jobs advertised in printed media, such as newspapers or job posting boards where written descriptions of jobs printed on paper were posted to the board. To apply for an available job, the job applicant typically submitted a resume on paper. For instance, to seek a job position available at a company, the job applicant would mail their resume to an address associated with a human resources department listed in the advertisement. After receiving the resume, a portion of the information from the resume was entered, often manually, into an applicant tracking system.

Today, the tasks described above are more and more being performed electronically. Jobs are advertised electronically and applicants submit their resumes electronically. The submission of the resume electronically allows for a larger set of information to be automatically transferred to the applicant tracking system as compared to the process of manual entry from a paper resume. Some advantages of performing these recruiting tasks electronically are the ability to reach a greater pool of applicants and the ability to obtain greater amounts of searchable data about the applicants.

In recruiting, at some point a manual filtering process takes place. In the manual filtering process, recruiters select particular applicants for greater scrutiny, such as an interview. A disadvantage of performing the recruiting tasks electronically is that so much data can be received from so many different applicants that the task of filtering the applicant data to determine which applicants to recruit becomes difficult and time consuming. For example, hundreds or even thousands of resumes can be received for a single job opening. As a result of the difficulties associated with filtering large amounts of applicant data received electronically, many opportunities for recruiting potentially valuable employees are lost because their information can't be separated from the vast pool of applicant data that is received. Thus, the value of electronic recruiting, such as enabled by applicant tracking systems, is greatly reduced. In view of the above, new methods and apparatus for electronic recruiting are desired.

### SUMMARY OF THE INVENTION

A recruitment enhancement system is disclosed that can be used by job recruiters to assess job applicant's suitability for particular jobs. The recruitment enhancement system can maintain and regularly update a proprietary database of individuals where the individuals can be scored or ranked within a profession. In one embodiment, a score or rank can be developed for a software developer in the software development profession. However, scores and ranks can also developed for individuals in other professions as well and the example of the software development professions is provided for the purposes of illustration only.

In various embodiments, the recruitment enhancement system can be configured to receive a recruitment service request from an outside entity. On type of service request can be a request for a rank or score of a number of individuals named in the request. The system can be configured to try to match the names received in the request to individuals that have been previously scored or ranked where scored individual's information is maintained in database. A report can be generated that includes information about the matched individuals and returned in a response to the request.

One aspect of the present invention can be generally characterized as a method of electronic job recruiting in a server including a processor and memory. The method can include 1) receiving in the processor information associated with professional skills of a first plurality of individuals; 2) for each the first plurality of individuals, generating in the processor from the received information a score where the score provides a qualitative indicator of an aptitude at a profession associated with the professional skills; 3) storing by the processor at least the score and identification information for each of the first plurality of individuals; 4) receiving in the processor a recruitment service request including information associated with a second plurality of individuals; 5) based upon the information received in the service request, determining in the processor whether each of the second plurality of individuals matches one of the first plurality of individuals; and 6) generating in the processor a response to the recruitment service requests that includes each of the second of plurality of individuals that are matched to one of the first plurality of individuals and the score for the matched individuals. In one embodiment, the profession is a software developer and the professional skills include software development skills.

### BRIEF DESCRIPTION OF THE DRAWINGS

FIG. 1 is a block diagram of a recruitment ecosystem in accordance with an embodiment of the present invention.

FIG. 2 is a block diagram of a recruitment enhancement system in accordance with an embodiment of the present invention.

FIG. 3 is a block diagram of a recruitment enhancement system including a developer database interacting with two applicant tracking systems in accordance with an embodiment of the present invention.

FIGS. 4A and 4B are examples of information communicated between a recruitment enhancement system and an applicant tracking system in accordance with an embodiment of the present invention.

FIG. 5 is a flow chart of a method of a recruitment enhancement system in accordance with an embodiment of the present invention.

### DETAILED DESCRIPTION

In the following paper, numerous specific details are set forth to provide a thorough understanding of the concepts underlying the described embodiments. It will be apparent, however, to one skilled in the art that the described embodiments may be practiced without some or all of these specific details. In other instances, well known process steps have not been described in detail in order to avoid unnecessarily obscuring the underlying concepts.

As will be described in more detail as follows, a recruitment enhancement system for electronic job recruiting system is described. The recruitment enhancement system is configured to gather and analyze information about job applicants. One objective of the analysis is to identify job applicants most likely to successfully perform jobs associated with available job positions. For example, a job applicant's proficiency or knowledge pertaining to a particular aspect of a job can be assessed and scored, such as their knowledge or proficiency of a particular programming language for a programming job. The scoring can be used to rank applicants.

The information derived from the analyses, such as the scores, can be referred to as job suitability parameters. The job suitability parameters can be designed to aid job recruiters during the manual filtering process of job applicants. The recruitment enhancement system can be configured to generate an interface that allows job recruiters to access the job suitability parameters for various candidates.

The recruitment enhancement system can be configured to gather information used to derive job suitability parameters directly or indirectly. Direct information gathering can involve configuring an activity and then getting a job applicant or a potential job applicant to engage in the activity. When the job applicant engages in the activity, information from the user's participation can be gathered and analyzed. For example, the job applicant can be asked to engage in a knowledge based contest related to a skill associated with a job. The job applicant's answers can be scored or evaluated in some manner to provide some indication of the applicant's skill level.

Indirect information gathering can involve harvesting information from a job applicant's online activities. One source of information that can be gathered an analyzed may be from an applicant's participation in social media activities. Another source of information that can be gathered and analyzed may be from an applicant's participation in professional related activities. Many potential information sources are available and these examples are provided for the purposes of illustration only and are not meant to be limiting.

As an example of an information source associated with professional related activities that can be used to generate a job suitability parameter, computer programmers often post publically available code related to personal projects. Their projects can be followed by other programmers. A recruitment enhancement system can be configured to gather and analyze the code to assess the programmer's abilities and suitability for various programming jobs. From the analyses, job suitability parameters can be derived that are made available to job recruiters. In one embodiment, a proprietary database can be maintained at the recruitment enhancement system that includes data about individuals whose skills have been analyzed in this manner.

The job recruiters can use the job suitability parameters, such as job suitability parameters derived for programmers stored in a proprietary database, in the next stages of the recruitment process. For example, the job recruiters can use the job suitability parameters to assemble a list of potential candidates they wish to vet in more detail and then possibly contact. The job suitability parameters can be used to rank each of the potential candidates. Thus, the job recruiters may use the job suitability parameters to establish an order in which to contact potential candidates.

In particular embodiments, the recruitment enhancement system can be configured to receive identifying information for a group of individuals from a job recruiter. As an example, a plug-in module can be provided for the recruiter's applicant tracking system (ATS) that generates and sends the identifying information related to the individuals to the recruitment enhancement system. In response to receiving the identifying information from the ATS, the recruitment enhancement system can be configured to determine whether one or more of the identified individuals from the ATS can be matched to individuals stored in one or more of the proprietary databases maintained at the recruitment enhancement system. For each of the individuals that are matched, a report can be generated. The report can include job suitability parameters for the matched individuals including how the individuals rank relative to the other individuals stored in the proprietary database. The report can be returned to the recruiter.

With respect to the following figures, details of apparatus and methodology for generating and maintaining a proprietary database of skilled individuals in a recruitment enhancement system where the skilled individuals can be scored or ranked are described. In addition, recruiting services utilizing these proprietary databases is described. The skilled individuals can be members of a variety of different professions. In one embodiment, the skilled individuals can be software developers. However, the discussion in regards to the software developers is provided for the purpose of illustration only and is not meant to be limiting.

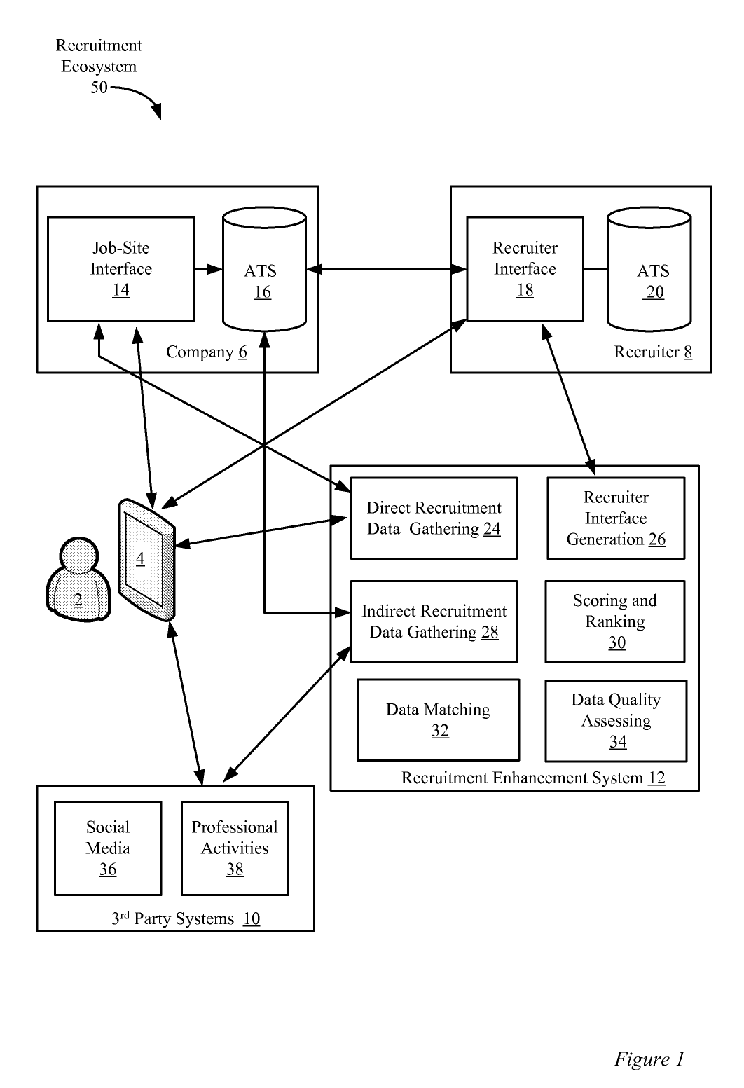

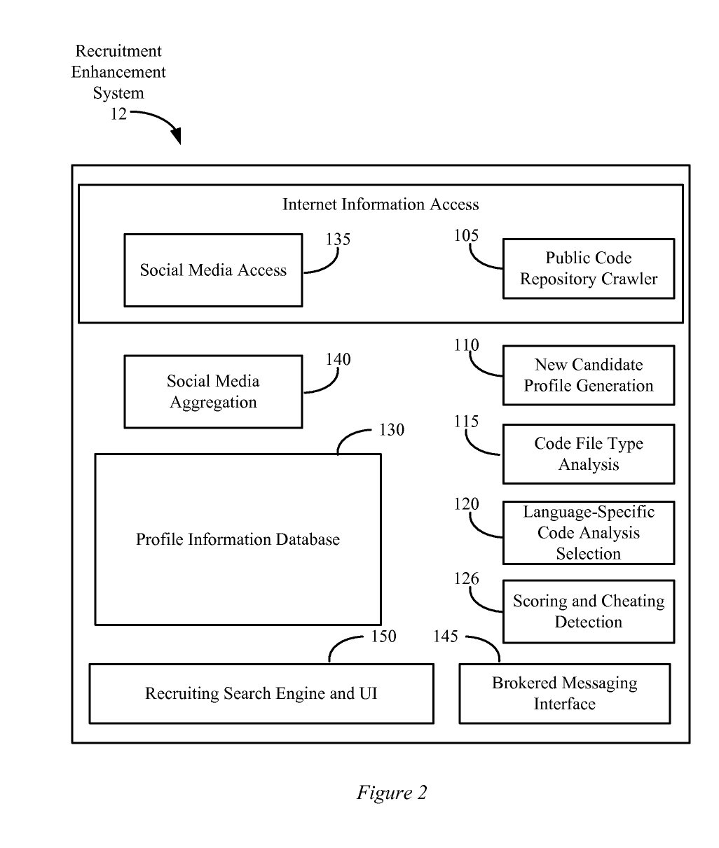

In particular with respect to FIG. 1, a recruitment ecosystem is described. Within the recruitment ecosystem, interactions involving individuals seeking jobs, recruiters seeking candidates, companies providing jobs and a recruitment enhancement system are discussed. With respect to FIG. 2, a recruitment enhancement system is described. In particular, methods and apparatus for formulating a proprietary database of information relating to skilled individuals are discussed.

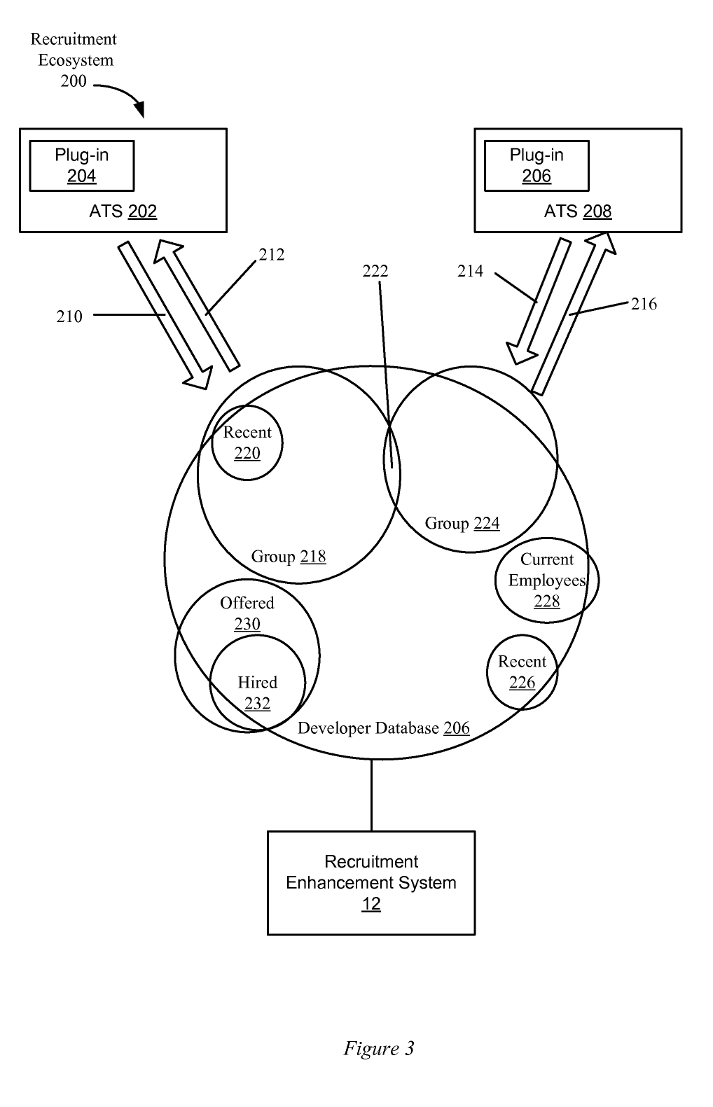

With respect to FIG. 3, 4A, 4B, 5, methods and apparatus for recruiting services that leverage the proprietary databases maintained within the recruitment enhancement system are discussed. The recruiting services can involve receiving a list of individuals from a recruiter and attempting to match individuals from the list to individuals stored in the proprietary databases. Reports can be generated for matched individuals on the recruiters list and returned to the recruiter. The recruiter can use information in the report to further their recruiting activities.

### Recruiting Ecosystem Including Recruitment Enhancement System

In this section a recruiting ecosystem including a recruitment enhancement system is a described. In a recruiting ecosystem, individuals can engage with various electronic systems to supply information that allows them to apply for existing jobs or to be considered for future jobs when positions open up. In response to the supplied information, recruiters can select from among the individuals and attempt to initiate additional job recruiting related interactions. For instance, based upon the received data, a job recruiter can identify an individual and attempt to contact the person to set up an interview.

A job candidate can be a person that is interested in working for company and has agreed to provide information but may not have applied for a particular job. A job applicant can be a person that has applied for a job and agreed to provide information as part of the application process. As described herein, a recruitment enhancement system 12 can be provided that can be used to gather information and engage job candidates and job applicants alike.

In the recruitment enhancement system, methods and apparatus can be provided for gathering secondary recruitment data that is beyond the resume and other application data that is usually gathered in the job application process via applicant tracking systems. The secondary recruitment data can be analyzed and scored. Based upon the score, one or more rankings for a job candidate can be generated. In one embodiment, the secondary recruitment data and rankings can be stored in a proprietary database maintained at the recruitment enhancement system.

As an example of ranking or scoring, an individual in the recruitment enhancement system 12 can be ranked independent of or relative to a group of other job candidates or job applicants, such as a group of job applicants applying for the same job or a group of job candidates within the same profession. An independent rank can involve comparing the individual's performance to some derived scale. A relative rank can involve comparing the individual's performance to other individuals within a group.

In one scenario, as will be described in more detail with respect to FIGS. 3, 4A, 4B and 5, a company can send information related to a group of individuals that have recently applied for job, have applied for a job in the past or have provided information indicating their interest in working for the company. The information associated with these individuals can be stored in a company ATS (applicant tracking system). Upon receiving the information, the recruitment enhancement system can be configured to rank the group of individuals one or more different ways. For instance, individuals recently applying for jobs can be compared against individuals that have been hired by the company. In another example, the group of individuals can be compared against a group of individuals stored in a proprietary database associated with the recruitment enhancement system.

The recruitment enhancement system 12 can be configured to generate an interface that allows an outside entity such as a job recruiter to access the ranking data. The outside entity can use the ranking data as a basis for additional investigations, such as learning more about particular individuals, and determining whether to contact particular individuals for additional interactions, such as a job interview. In one embodiment, as described in more detail with respect to FIG. 3, the interface can be provided as a part of a plug-in application for their ATS.

In particular embodiments, the recruitment enhancement system 12 can be tailored to particular professions. For example, the recruitment enhancement system 12 can be tailored towards the computer programming profession where the system is configured to gather secondary recruitment data that allows computer programming professionals to be ranked according to some scale and/or relative to other computer programming professionals that have participated in a common recruitment enhancement activity. A recruitment enhancement system associated with program developers is described below in more detail with respect to FIG. 2. In another example, the recruitment enhancement system 12 can be tailored towards medical professionals, such as doctors or nurses, where the system is configured to gather secondary recruitment data that allows the doctors or nurses to be ranked.

FIG. 1 is a block diagram of a recruitment ecosystem 50 including a recruitment enhancement system 12 in accordance with the described embodiments. The ecosystem 50 includes company systems, such as 6, recruiter systems, such as 8, a recruitment enhancement system, such as 12 and 3^{rd} party systems where individuals can engage in various activities, such as 10. Social media sites are one example of 3^{rd} party systems. An individual 2, who may or may not be currently engaged in the job hunting process may interact at various times with each of the systems via a computational device, such as the tablet device 4. Typically, the interactions may involve establishing communications between the computational device and one or more remote servers associated with each of the systems over a local and/or wide area network. For instance, the tablet device 4 can be used to establish communications and interact with a server associated with a social media site.

Communication devices typically include a processor, a memory, networking capabilities and a user interface that allows for the input and output of data. Examples of communication devices that can be utilized include but are not limited to smartphones, latptop computers, netbook computers, desktop computers and tablet computers. Interface devices that can be utilized include a display, a keyboard, and a microphone in combination with speech recognition, a mouse, a touchpad and a touchscreen.

The recruitment enhancement system 12 can include components for a) direct gathering of recruitment data 24, b) generating a recruiter interface 26, c) indirect gathering of recruitment data 28, d) scoring and ranking 30, e) data matching 32 and f) data quality assessing. The system 12 can be hosted on one or more servers including processors, memory and network interfaces. Direct recruitment data gathering 24 can involve generating one or more activities in which an individual can directly participate, such as a knowledge-based test, a game, a puzzle or solving a problem. The direct recruitment data gathering can be used to identify and engage individuals that have interest in a company or encourage individuals to be interested in a company. In addition, the direct recruitment data gathering can be used to possibly assess potential job candidates.

In general, the capturing of data from an individual directly engaging in an activity can be part of direct recruitment data gathering. For instance, an individual engaging in an activity, such as an interview, can be captured on video data as part of direct recruitment data gathering 24. In another example, when an individual takes a test, information such as their answers, how long they take to answer each question and their total time can be gathered and analyzed.

The indirect recruitment data gathering can involve gathering information from an individual's on-line activities, such as participation in social media sites 36, professional sites 38 or even sites related to a user's hobbies. The person's on-line activities can be hosted on 3^{rd} party systems 10, such as a social media site. In one embodiment, when a user agrees to participate in an activity involving direct recruitment data gathering, a user may agree to provide access to their on-line activity information which can be captured by component 28. For example, a user can provide access to their Facebook™ or Linkedin™ profile for a chance to participate in a knowledge-based test related to recruiting. The knowledge-based test can be referred to a recruitment enhancement activity. After access is granted, the indirect recruitment data gathering component 28 can retrieve information about their on-line activities from the 3^{rd} party systems.

The information gathered by components 24 and 28 can be stored and analyzed. Then, job suitability parameters can be derived. For example, the scoring and ranking components 30 can be used to score information directly gathered during an online test and then rank individuals based upon the scores. In addition, information about an individual's online activities can be gathered indirectly from various third-party systems 10 and job suitability parameters can be derived from this information. For example, based upon software code that a user has posted to a professional site, the individual's coding ability can be scored and ranked. The software code may be executable. However, the software code doesn't have to be executable to generate a score or a ranking. Methods related to scoring code are described below with respect to FIG. 2.

In particular embodiments, scores and ranks can be derived from data that is gathered directly and/or indirectly. For example, as will be described below, a score and/or a rank can be generated based upon an individual's participation in a knowledge-based test. In another example, a score and a rank can be generated based upon an individual's participation in a knowledge based test and information retrieved from a third-party site, such as social media site. Again, a person can be ranked relative to a group of other individuals, such as a group of individuals participating in a common task, or according to some derived scale or measure.

The data matching component 32 can be used to match various data sets to a particular individual. For example, an individual may use multiple names in their on-line activities. As another example, different individuals can share a common name. The data matching component 32 may use information verified from one source to validate another information source. For example, if an individual grants access to their Facebook™ profile and then another source of information is available, such as their profile in a professional organization or data that they have supplied in applying for a job, the information from the two sources can be compared by component 32 to see if they are the same person. When the comparison indicates they are the same person, a portion of the information from the multiple sources can be stored at the system 12 or at least the links to the multiple sources can be stored. This information can be made available in a recruiter interface.

The data quality assessing component 34 can be used to assess a validity of gathered data. For example, the component 34 might be used to determine whether someone has cheated on a knowledge-based test administered by system 12 or tried to game the system 12 in some other manner. As another example, the component 34 might be used to determine whether a person has falsified data they have provided as part of a job application. Information that is identified as invalid may be flagged. In addition, the system 12 can be configured not to use information identified as possibly invalid for scoring and ranking purposes.

The recruiter interface 26 can allow recruiters to directly access some portion of the information available at system 12. For example, via the interface, recruiters may be able to access scores and ranks about various individuals. Further, via the interface a recruiter may be able to search for individuals with particular skills and assess their job suitability parameters, such as scores and ranking. In another embodiment, as described in more detail with respect to FIG. 3, a recruiter can access the system 12 via a plug-in module coupled to their ATS, such as 16 or 20.

The company 6 and the recruiter 8 can each maintain applicant tracking systems, such as 16 and 20. If a recruiter 8 works for the company 6, then the recruiter 8 may not maintain a separate applicant tracking system. The recruiter 8 may have access to an interface or interfaces that allows them to interact with the recruitment enhancement system 12, an individual 2 via their device 4 or some other mechanism, their own application tracking system 20 and a company application tracking system 16.

The company 6 can sponsor a job-site interface 16. Via the job site interface 14, an individual, such as 2, may be able to learn about different jobs and optional apply for jobs. Information from the job application process can be stored to the company application tracking system 16. In particular embodiments, the company 6 may allow recruiters, such as 8, and/or the recruitment enhancement system to access the application tracking system 16.

In one embodiment, one or more direct recruitment data gathering activities can be triggered from the job-site interface 14. For example, when a user applies for a particular job, such as after submitting their information or a part of submitting their information, a link can be established from the job-site interface 14 to the recruitment enhancement system 12. The recruitment enhance system 12 can then generate a recruitment enhancement activity that is used to directly gathered recruitment data. For example, as part of the recruitment enhancement activity an individual may be asked to take a knowledge-based test, play a game, solve a puzzle, solve a problem or combinations thereof.

Information captured from the recruitment enhancement activity can be scored or ranked and made available to recruiters via the interface generated by the recruiter interface generation component 26. An individual can participate in a number of different recruitment activities. Thus, the interface may allow a recruiter to view descriptions of the recruitment enhancement activities in which an individual has participated and jobs suitability parameters derived from their performance.

In one embodiment, via the interface, a recruiter may be able to send a request to an individual to participate in a particular recruitment enhancement activity. For instance, the recruiter may be interested in an individual for a particular job position. Via the interface, the recruiter can send a message to the individual indicating their interest in the person and requesting them to participate in a recruitment enhancement activity, such as taking a knowledge-based test associated with the job position. The message received by the individual can include information, such as a link to a web-site, which allows the individual to engage in the recruitment enhancement activity.

In one embodiment, the recruitment activity that is selected can be related to information associated with an available job. For example, a knowledge-based test can be implemented that is related to a skill needed for the job position. Their answers can be scored and the person can be ranked relative to other job applicants that have taken the test.

In other embodiment, the recruitment enhancement activity that is selected can be related to information supplied by the individual applying for the job. Via interface 14, an individual can submit information indicating that they possess a particular skill at a particular skill level, such as a number of years of experience in the skill. For instance, the interface can ask the person to indicate how many years of experience the person has with the skill or the person can submit a resume including this information.

Based upon information supplied by the individual, the system 12 can be configured to select a recruitment enhancement activity that in some way measures or is predictive of the person having the claimed skill. For example, an individual can be asked to take a knowledge-based test associated with their claimed skill. Harder or easier test can be implemented depending upon the person's claimed skill level. The test answers can be received by the system 12, scored and analyzed. The scores and analyses can be used to assess individuals in regards to their proficiency in the claimed skill. In addition, the individual can be ranked relative to other individuals with the same claimed skill level or according to a scale constructed for individuals of the claimed skill level. The system 12 can be configured to make information about an individual's score or rank in the recruitment enhancement activity available to recruiters.

### Recruitment Enhancement System

FIG. 2 illustrates in more detail a functional block diagram of a recruitment enhancement system 12 in accordance with an embodiment of the present invention. The recruitment enhancement system may reside on one or more servers with associated processors and memory, wherein the computer code is stored on a computer readable memory. A database memory may be provided to store information for the recruiting service, including candidate profile information.

In the example below, the generation of a database, which may be a proprietary database, is described. The database is focused on individuals that are software developers. The use of software developers is provided for the purposes of illustration only and databases associated with individuals in other skilled professions can also be generated and maintained at the recruitment enhancement system.

A crawler 105 is provided to crawl code repositories. For example, the crawler may use an API for code hosting sites such as GitHub. A new candidate profile generation module 110 determines whether the crawler has identified a new developer. If so, a profile ID is generated to build a new profile. A code file type analysis module 115 determined the file type of files being crawled. After the file type has been determined, the language-specific code analysis module is selected by module 120. Scoring and cheating detection is then performed by module 125.

Profiles are stored in a profile information database 130. A social media access module 135 provides access to social media information sites and a social media aggregation module 140 correlates aggregated social media information for individual profiles. A messaging interface 145 is included in one embodiment as a mechanism for recruiters to contact individual developers. However it will be understood the messaging interface 145 may be omitted in some implementations. The messaging may, for example, be brokered in the sense of cloaking the user information and email address of the recruiter during initial attempts to contact a developer. A recruiting search engine and graphical user interface (GUI) module 150 is responsible for generating the graphical user interface that is provided for display on a user's computer. In one embodiment, the recruiter's search engine and GUI module can be configured to interact with a plug-in module that is provided to the recruiter's ATS (e.g., see FIG. 3).

The new candidate profile generation module 110 utilizes author information from crawled sites to detect that there is a new developer to be added to the system. Code repository sites include author information for each project. This author information is searched by the crawler. Each individual person with a profile has a unique ID. The unique ID is created the first time an individual programmer's name is discovered in crawling author information in code hosting sites. For example, when the crawler finds the names of people that have contributed code to a code hosting site, the system compares the unique ID from the network that the person is found on to the unique IDs in the database of the recruiting service for that network. If an ID doesn't exist, a new user ID is created.

The crawling process generated project information for each developer. One way to obtain project information for a particular person is specifically ask a code hosting site (or content site like Stack Overflow) for a list of projects for each developer. For example, this may be done through an API for sites such as GitHub and Stack Overflow.

The crawling is updated regularly and the profiles are refreshed according to a cycle. An exemplary refresh cycle is a two-week profile refresh cycle. That is to say, the update from the crawlers may be constant, but the profiles may be updated according to a schedule, such as every two weeks.

One aspect of the crawling process is that the source code for a particular project is downloaded for analysis. As illustrative examples, the source may be downloaded using technologies such as Git, SVN, Mercury, and CVS, which are technologies that allow for synchronization with the local computer of a code repository.

It is preferable to download all of the available information in a repository for analysis. However, note that the source code for a project may be in any one of a variety of different file types.

Downloaded files are then processed, starting first with the code file type analysis module 115. An individual file is analyzed to determine what's in it by looking at file extensions and the binary data or text that the file contains. Specific patterns in the source code are analyzed. For example, specific languages—like Ruby—always start with a certain few lines of code—e.g. the hashbang—so that by looking for the patterns of a specific set of keywords in the file permits the language to be identified. Additionally, the analysis of the code can include looking for the “magic number” —a set of bytes at the beginning of the file that indicates file type. For example, images always start with a specific byte configuration. The pattern associated with each different file type is checked until a match is found. The pattern matching may be performed, for example, using a sequence of if-then clauses to identify the file type of a particular file.

After the file type is determined, the language specific code analysis selection module 120 makes a selection of an evaluation tool or tools appropriate for the language of the file type. Most software languages have evaluation tools to evaluate the quality and complexity of the coding. The evaluation tools are specific to a particular language and may, for example, look at the length of the code and patterns in the code. For many cases, the evaluation tools for a specific language are open source and/or available from commercial vendors. For example, there is a unique set of tools to evaluate Ruby—tools that differ from those used to evaluate C++. Thus if the recruiting service is designed to analyze code in languages such as Java, Scala, Shell, ActionScript, XML, CSS, HTML, Groovy, PHP, Perl, Python, Lisp, etc. then the system includes the corresponding evaluation tool for each supported language. Thus, the recruiting service includes a wide range of evaluation tools to support different languages and makes the selection of the proper evaluation tool based on the file type. The file is then analyzed using the appropriate selected tool(s) for the language associated with the file type.

The scoring and cheating detection module 125 utilizes the evaluation of the code and also information from the commit log for the file. To identify the author of the code of a particular file, the commit log is evaluated for the repository. The commit log is a list of who did what for the repository. This permits an evaluation of the developer's specific contribution(s) to that project. For example, by analyzing the commit log an evaluation can be made of the time(s) when the developer made a contribution.

The process is continued for all of the developer's repositories to permit a determination to be made of what languages that a person has experience in and how much experience the person has in each language. Recruiting service downloads all the developer's repositories and evaluates their contributions to determine the languages they've written code in. To evaluate experience the commit log is examined to look at the date and time of when the developer contributed to the project. Different factors can be used to determine actual experience. One factor is that contributions can be evaluated by their frequency and regularity to weight the actual number of years of experience in a particular language.

As an illustrative example, consider a developer named Joe. If Joe started contributing to a project 3 years ago, and the commit log shows that he's been contributing regularly to it, that's an indication that he has 3 years of actual experience. Thus, a weighting function can take into account the frequency and regularity of Joe's contributions. For example, if Joe has been making four or more contributions per year that's an indication that Joe has been regularly working on Java.

However, if Joe made a single contribution 3 years ago and just contributed again for the first time 2 months ago, then the commit log indicates “episodic” contributions with a wide spacing between contributions. For this second case, the weighting factor can be used to reduce Joe's number of years of experience such that he does not get 3 years of experience credit. The exact weighting function chosen can be empirically determined based on common behavior patterns of software developers. For example, if the commit log shows Joe made a single contribution to a Java project 3 years ago and made a second smaller contribution a month ago there could be a possibility that Joe is either 1) trying to “inflate” his resume about the number of years of experience he has in Java; or 2) may have become aware of the recruiting service and is intentionally trying to trick the recruiting service. In this example, the weighting function may also include one or more rules to discount recent contributions, particularly those of a minor character, such as a minor code tweak or a contribution made with many other contributors.

Thus, while the raw data provides an indication of a maximum potential number of years of experience, a weighting function may include different factors related to frequency of contribution, size of contribution, and number of co-contributors to perform a weighting function to arrive at a more accurate interpretation of the number of years of experience for a developer. The weighting function may be determined empirically, based on observations about the way software developers normally work, to optimize different weighting factors and periodically adjusted to discourage gaming of the system. Other types of gaming (such as posting the same code at different times on different sites or plagiarizing code from others) could also, in theory, be checked as part of a larger fraud detection function.

As an illustrative example, patterns in a commit log may be examined for suspicious factors of how the developer is developing his/her source code. The simplest example of a developer cheating is that the developer downloads someone else's source code, opens their own repository, and submits that same exact code to the new repository. In that case, there would be a huge update all at once, and then nothing else in terms of activity. This is inconsistent with normal commit log behavior in which a user normally makes a series of regular contributions over time. An honest developer would normally (except for perhaps extremely small projects) be consistently committing code they are developing for their project. As a result when a huge aberrant spike occurs in a commit log a presumption can be made that there is a high likelihood that cheating has occurred. In this case, the weighting function can severely or totally discount the project, i.e., give it extremely little or no credit.

As previously described, in one embodiment there are three kinds of scores that are calculated for each developer. These include knowledge, experience and influence. This level of scoring provides a variety of useful information to evaluate candidates. However it will be understand that the recruiting service could also be implemented with a subset of this set of scores.

The scores are preferably calculated on a language-specific basis and an overall basis. Language specific scores are useful to evaluate skills in a particular language. However, generating an overall score provides an additional indicator of a developer's talent.

An exemplary language-specific scoring process will now be described. In one implementation, to determine a knowledge score, an examination is made of lines of code and the number of repositories that the developer has contributed to. The score is then calculated by a function that weights the total number of lines of code in all of the different repositories. That is, a developer who has written more lines of code has more experience and credit is given for contributing to different repositories. However, the number of lines of code can reach very large numbers. Thus, one way to score knowledge is apply a logarithm function based on the number of lines of code. As one example, a knowledge score for a developer can be generated using a natural log curve: ln(lines)×number of repositories, where “x” is the multiplication operation and this equation is a simplified equation to illustrate a general approach that one of ordinary skill in the art would further optimize for a particular implementation to optimize empirical results. Other variations based on a logarithm function are also possible and other factors could be included in determining a knowledge score.

An exemplary language-specific scoring process for experience looks at different factors indicative of experience and then weights the factors. For example, to calculate a total experience score the individual experience scores may be combined with work experience, i.e., Total Experience=Individual experience skill experience scores×work experience. Of course, many variations are possible in terms of weighting individual skills experience with work experience. In one implementation the process looks at the lines of code that have been written with particular attention to the lines of code written per day, in addition to commits per day, and the number of days of activity. A weighted function SUM(r) can be used to perform an initial analysis of experience in different skills. The scoring can be further weighted by work experience, resulting in simplified equation to determine a language-specific experience score: SUM(r)×Work Experience, where this equation is a simplified equation to illustrate a general approach that one of ordinary skill in the art would further optimize for a particular implementation to optimize empirical results.

An overall score can be calculating by weighting individual scores. An overall experience score can be determined as follows:

Experience=Individual experience skill experience scores×work experience.

An overall knowledge score can be determined using different weighting approaches. In one approach a logarithm function is used to weight the sum of different knowledge skill scores so that a high score requires the developer to have a wide variety of skills: Knowledge=ln(SUM(Skill Knowledge)), where this equation is a simplified equation to illustrate a general approach that one of ordinary skill in the art would further optimize for a particular implementation to optimize empirical results.

The influence score is a measure of the developer's influence in the larger developer community. In one embodiment the influence score includes how much the developer's code influences other developers. Additionally the influence score may include the developer's influence in social media. For example, the influence score may include a component based on how a developer's projects have influenced others, based for example on the number of followers, forks, and contributors, which may be determined from data within code hosting repositories. However, an individual developer may have different influence in different languages, which has to be taken into account in determining an overall influence score. Additionally, the developer's influence in social media may also be considered, such as weighting the influence in social media by a weighting function. For example, one measure of influence in social media is a Klout score. Thus an exemplary overall influence score may be determined as follows:

Influence=f(Klout)+ln(SUM(Skill Influence))

where a developer is given credit for influence in different skills may also be given some credit for social media influence and where this equation is a simplified equation to illustrate a general approach that one of ordinary skill in the art would further optimize for a particular implementation to optimize empirical results.

The scoring and weighting functions that are applied are determined empirically to give a desired distribution based, for example by examining what weighting functions give the best real-world results at a particular point in time for recruiters. Thus, for example, the actual constants used as weighting factors and aspects of the weighting functions may be varied based on feedback on the usefulness of the scoring for simulated or actual recruiting efforts.

For example, when calculating knowledge, one approach is to look for extensive experience in several languages. This is because in the real world highly knowledgeable developers have a broad range of experiences to draw upon and are skilled in different languages. Thus, even if a developer has top 10% scores in one or two languages, they cannot get a top 10% overall knowledge score, because that only happens when the developer has top-tier scores in several languages. That is to say, breadth counts.

The public code repositories are crawled on a regular basis. In one embodiment all the raw data obtained from a crawl of the public code repositories is saved, except for the source code. That is, it is preferable to save the information obtained by analyzing the code, in addition to the source log itself. The next time the crawler encounters that repository, the source code is downloaded again, and a “refresh” is made based on new contributions. Additionally, the logs are checked to determine the individual(s) that made the new contribution. Thus, if Michael has a repository with a project, the system will also confirm from the log entries which contributors made any new contributions. Thus if Luca makes a follow-on contribution to Michael's project, the follow-on contribution will be credited to Luca. This cross-checking of which individual made which new contribution to a project is useful to improve accuracy and reliability of the scoring.

The social media access module 135 and the social media aggregation module 140 provide a comprehensive set of social media links for each profile. The author information obtained from public repository sites such as GitHub and Stack Overflow may be incomplete or contain inaccuracies. However typically the author information will include at least an email address and perhaps also a name. This information can then be used to obtain additional social media information using commercial services such as Full Contact, Inc. of Denver, Colo., Fliptop, Inc. of San Francisco, Calif. and Rap Leaf of San Francisco, Calif. Many commercial services check by unique information, like email address, or a hash of the email address (a hash is a unique number generated by an email address. That way, companies can match users by email addresses, but protect their privacy by looking at hash numbers). In one embodiment a search of social media sites is performed of all of the sites listed under Full Contact's set of Social Network Types. From this information profile information identifying the names of developers may be generated along with associated information. For example, work history may also be scraped from social networking sites.

Direct scanning of social media sites is also an option, such as the option of scanning sites such as LinkedIn and Google Plus. However, there's usually not a one-to-one results process. For example, if a developer has a common name, such as “John Smith,” a scan based on their name may turn up more than one hit. To find additional social media links for a particular profile it is thus desirable to look for multiple matching factors (location, title, company, name, etc.), and then calculate the probability that it's a match. If the probability is higher than a certain number, the system automatically merges the profiles. If the probability is less than that threshold, the system sends a notification that there needs to be a manual review process.

In one embodiment, an individual may have granted the recruitment enhancement system access to one of their profiles at a social media site. For example, to participate in contest, which is an example of a recruitment enhancement activity described with respect to FIG. 1, the individual may have given the recruitment enhancement system permission to access their profile at Linkedin™ When permission is granted in this way, the recruitment enhancement system may be able to access more information about the individual than when social media sites are directly scanned. Once links to social media are identified for a developer they can be refreshed at a rate slower than other information in the public code repositories. Individuals typically add new social networks infrequently and the URLs of social media sites are generally static.

### Recruiting Services Using a Recruitment Enhancement System

In this section, recruitment services that leverage information gathered and analyzed at the recruitment enhancement system are described. In addition, interfaces that allow outside entities to access these services are described. For instance, an interface can be provided for an applicant tracking system that allows a recruiter to access recruitment services, such as candidate scoring, from a recruitment enhancement system.

FIG. 3 is a block diagram of recruitment ecosystem 200. The recruitment ecosystem 200 includes two applicant tracking systems (ATSs), 202 and 208 and a recruitment enhancement system 12 including a developer database 206. The developer database 206 includes information about software developers. This example is provided for the purposes of illustration only as the recruitment ecosystem 200 can include a plurality of different applicant tracking systems. In addition, as is described in more detail below, the recruitment enhancement system 12 can be configured to provide access interfaces that don't require an ATS. Further, database 206 can include information about individuals from other professions other than software developers and/or separate databases (not shown) can be maintained for individuals in other professions.

The applicant tracking systems, 202 and 208, can include data associated with a plurality of individuals that have applied for jobs over some period of time. In applying for a job, each individual may have supplied information that is stored to an ATS. For example, an individual may have electronic uploaded a resume in some format. After the resume is uploaded, the resume may be processed. For example, optical character recognition can be applied to a scanned in image of the resume.

After processing, information from the resume can be parsed and stored to an ATS database. The format of the database including the record structure and the information stored in the database can vary from ATS system to ATS system. For example, ATS 202 can store a first set of applicant information in a first order and ATS 208 can store a second set of applicant information in a second order.

As another example, the ATSs may also include information about individuals that have expressed interest in the company through some mechanism, such as a social media application. For example, via a social media application a user may have requested interest in a company and supplied a name and e-mail to receive some type of information. As another example, via a social media application, a user may have provided a social media profile to participate in a company related activity. Information obtained via a mechanism, such as a social media application, can be stored to the ATS. Thus, in general, there are many different scenarios in which information can be gathered about an individual and then entered into an ATS and information obtained via the job application process is only one example in which information about an individual can be provided to an ATS.

The ATSs can be associated with different entities. For example, ATS 202 can be associated with a first company where it includes information for applicants that have applied for jobs at the first company and ATS 202 can be associated with a second company where it includes information for applicants that have applied for jobs at the second company. As another example, ATS 202 can be associated with a first recruiter that has performed recruitment searches for a first group of companies and ATS 208 can be associated with a second recruiter that has performed recruitment searches for a second group of companies different from the first group. Thus, individuals in one ATS may have applied for jobs at different companies serviced by a recruiter or group of recruiters.

In some instances, information stored in each of the ATSs can overlap. For instance, when ATS 202 and ATS 208 are associated with companies in the same field, it is possible that the same individual has applied for jobs at each of the companies. Thus, ATS 202 and ATS 208 can include information, such as resume information associated with the same individual. However, because companies and recruiters usually closely guard the information stored in their ATS and don't generally share the information, neither of the entities controlling ATS 202 or ATS 208 is likely to know about the overlaps between their ATS databases.

Using an ATS database, such as 202 and 208, a recruiter can perform searches over the records in the ATS database. A search can allow a recruiter to identify a group of records that satisfy particular search criteria. For example, if the database stores information related to an individual's experience level with a particular programming language, then a recruiter can perform a search for candidates satisfying the experience level requirements for a particular job. The outcome of the search can be a list of candidates meeting the search criteria and information about each candidate.

After searching, a recruiter can choose to contact various individuals for additional scrutiny, such as interviews. The recruiter may continue to contact individuals represented in the ATS until a job position is filled. After the job position is filled, the information about individuals that were not hired may still remain in the ATS. Thus, search results can include information about job applicants that have applied for a particular job opening, information about individuals that have previously applied for other jobs and individuals that have been entered into the ATS through other mechanisms, such as via a social media application.

In particular embodiments, information about all or a portion of the candidates in an ATS can be sent to the recruitment enhancement system 12. As an example, in 210, information about one or more individuals stored in ATS 202 can be sent to recruitment enhancement system 12. As another example, in 214, information about one or more individuals stored in ATS 208 can be sent to the recruitment enhancement system 12.

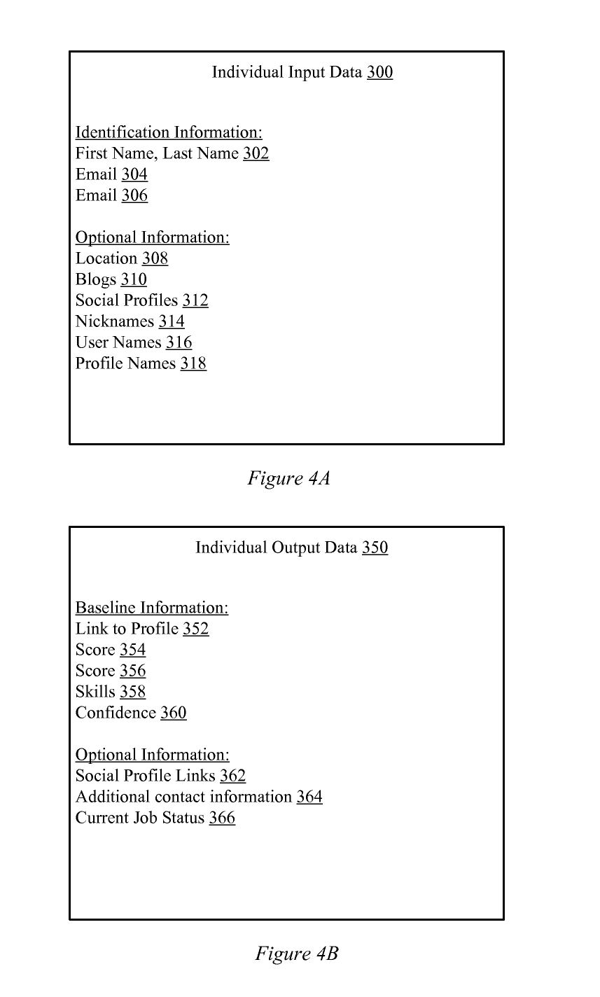

The information sent from the ATS to the recruitment enhancement system 12 can be used to provide a recruitment enhancement service. In various embodiments, as will be described in more detail below, one recruitment enhancement service can involve scoring or ranking individuals, such as software developers, which are identified from the information received from ATS in a recruitment service request. Some examples of information that can be used to identify an individual that may be stored in an ATS and sent to system 12 are described with respect to FIG. 4A. Some examples of information that can be returned about an individual from system 12, such as but not limited to a score or a rank are described with respect to FIG. 4B.

Next, some of the information that can be sent to system 12 as part of a recruitment service request is described with respect to FIG. 4A. Then, additional details about FIG. 3 are described followed by a description of FIG. 4B. The individual in FIG. 4A can be one among group of individuals whose information is sent in 210 or 214. In a communication between an ATS and system 12, identification information about each individual, such as a first name and a last name 302, can be sent. In addition, one or more e-mail addresses, 304 and 306 can be sent that are believed to be associated with the identified individual. In one embodiment, the recruitment enhancement system requires a first name, last name and at least one e-mail address to provide a recruitment service involving assessing a skill level of the individual.

For competitive purposes and for privacy reasons, a company may not wish to release too much information about an individual. An individual name and e-mail address or addresses are likely to be publically available. Thus, an advantage of sending only a name and email addresses is it allows the company to maintain that it is protecting the privacy of individuals because only a limited amount of information is sent and what is sent is likely to be publically available.

Besides the name and the e-mail address or addresses, one or more additional types of information can be sent. The recruitment service may involve determining whether the recruitment enhancement system 12 has additional information about the named individual. Individuals can share names. Thus, the additional information may allow the system to confirm with a higher level of confidence that a named individual from an outside entity is properly identified by system 12.

Some example of additional information include but are not limited to location information 308, blog information 310, social profile information 312, nicknames 314, user names 316 and profile names. The location information 308 may be an address where the person lives or works. In one embodiment, the location information 308 may be a partial address, such as a city where the individual lives or works. The blog information 310 is example of information associated with an individual's on-line activities. For example, information 310 can be associated with a user's online blog, such as link (e.g., a URL) to the blog.

In another example, information 312 may be associated with an individual's on-line profile. For example, a link to a Linkedin™ profile or information obtained from the on-line profile can be sent. Multiple instances of information 312 can be sent. For instance, a first link to a first profile and a second link to a second profile can be sent. The system 12 can be configured to parse the received information when multiple instances of particular type of information or no instances of a particular type of information, such as 312, are received.

In other examples, information, such as nicknames 314, usernames 316 or profile names 318, associated with a user's on-line activities can be provided to system 12. As will be described in more detail as follows, the received information can be used to determine whether the named individual also has a record in the developer database 206 maintained by the recruitment enhancement system 12. In general, any information available at the ATS that can help to locate information about the individual in the developer database 206 or other database maintained at the recruitment enhancement system can be sent.

The information that is sent can vary from individual to individual. For example, for a first individual, a name and one e-mail address can be sent. For a second individual, a name and two e-mail addresses can be sent. For a third individual, a name, one e-mail address and a link to a social profile. For a fourth individual, a name, two e-mail addresses and a number of different user names can be sent. Thus, the recruitment enhancement system 12 can be configured parse and utilize different combinations of information that vary from individual to individual.

In a particular embodiment, the recruitment system can be configured to receive information about an unnamed individual. For example, the first name and last name 302 may not be known. Based upon the received information, the system 12 can be configured to determine a possible name of the individual and return the information to the entity that sent the information about the unnamed individual.

The information described above doesn't necessarily have be stored in or sent from an ATS. In one embodiment, the received information is used to locate information about individuals in a database maintained by the recruitment enhancement system 12. For this purpose, it doesn't matter where the information resides before it sent as long as it is suitable for locating records of individuals maintained in the database or databases of system 12. Thus, the example of an ATS as a source of the information sent to the recruitment enhancement system is for the purposes of illustration only and is not meant to be limiting.

In one embodiment, besides information about the individuals, information about a job position for which candidates are desired can be sent. For example, a portion of a job description can be sent in a recruitment service request. In one embodiment, when the system 12 receives a job description and a list of a number of individuals, the system 12 can be configured to store information about the individual and information about the job position for which they are being considered to a database maintained at system 12.

Returning to FIG. 3, in one embodiment, a plug-in module, such as 204 and 206, can be provided for an ATS. The plug-in module can be configured to be compatible with the recruitment enhancement system 12. The plug-in modules can be configured to extract information from an associated ATS and send it to the recruitment enhancement system in format that is recognizable by system 12.

In one embodiment, the plug-in module may provide an export feature. For instance, an export button can be located within an interface provided with the search functions of the ATS. In response to a search, a selection of the export feature can cause an electronic data file to be generated that is compatible with the recruitment enhancement system 12. The electronic data file can include information consistent with the search, such as the names and e-mail addresses of the individuals identified in the search. As described above with respect to FIG. 4A, additional information related to a particular individual can also be included.

An API (Application Program Interface) can be provided with system 12. The API can describe formats and particular data types that system 12 can accept. The API can be used by third-party developers to construct a plug-in module for an ATS.

The extracted information can be sent to the recruitment enhancement system in 210 or 214. The information can be sent as part of a recruitment service request. The plug-in module may require a user to provide an additional input before the data is sent, such as a selection of a send button. In one embodiment, the plug-in module, such as 204 or 206, can be configured to establish electronic communications with the recruitment enhancement system 12 and then send data to the recruitment enhancement system 12 that has been extracted from an ATS. The data can be sent electronically via a secure connection between the ATS and the recruitment enhancement system 12. The information that allows the secure connection to be established may have already been exchanged by the systems.

In one embodiment, entities can be charged according to their utilization of the recruitment enhancement system 12. Thus, the data sent from the ATS, such as 202 or 208, can include identification and authorization information for an entity requesting a service. The authorization information can be used to determine whether the entity sending the data is authorized to obtain a requested service from the recruitment enhancement system 12. The identification information may allow the recruitment enhancement system to attribute its utilization to the entity and bill it for the services.

Although not shown, the recruitment enhancement system 12 can be configured to provide an interface, such as web-based interface, that allows an entity to upload information that is compatible for receiving a service from system 12, such as a file including a list of names and e-mail addresses to the system. The system 12 can be configured to process the file and generate a report. Upon payment, entity can receive the report. The report can be emailed to an address specified by the entity or a link can be provided that allows the entity to download the report. Thus, a plug-in module that provides an interface to an ATS may not be required.

After receiving the individual information in 210 and 214, the system 12 is configured to determine whether it has information about the received individual's in its developer database 206. Possible results of this determination are shown graphically in FIG. 3. The largest circle represents individuals in the developer database 206. Group 218 can include one or more individuals from ATS 202. It can be seen that a circle associated with group 218 partially lies within the large circle associated with 206 and partially outside of it. The portion inside the circle represents individuals in group 218 that can be matched to individuals in the developer database 216. The portion outside the circle 206 represents the portion of individuals that can't be matched to individuals within the developer database 206 with an acceptable degree of confidence.

In this example, most of the individuals in group 218 were matched to individuals described in database 206. In other embodiments, it is possible no matches may be found. In yet other embodiments, it is possible that all of the individuals in a group, such as 218, can be matched to individuals in the database 206. Thus, the fractions shown in FIG. 3 are for the purposes of illustration only and are not meant to be limiting.

The system 12 can maintain a number of databases that identify individuals. The individuals can have different job skills and may be members of different professions. At some point, the system 12 may have received information that allows a score or a rank to be developed for the individual. In various embodiments, the scores or ranks can be an indicator of such factors, as the quality of their one or more job skills, their influence within their profession and their effectiveness at their profession. Details of generating these scores and ranks for software developers are described above with respect to FIG. 2.

When reporting the results of a search, the system 12 can report which individuals received in a group, such as 218, were matched to an individual in at least one database maintained at 12 and which individuals were not matched. For named individuals in a group that are matched to someone in the developer database 206 a confidence measure can be determined. The confidence measure may be based upon the amount of information that is matched. For example, a number of points can be given for a last name match, a number of points can be given for a first and last name match and a number of points can be given for each e-mail address match. The more information that is matched the higher score and hence the higher level of confidence that the named individual is a match for an individual in the developer database 206.

In one embodiment, when an individual is not matched or the confidence measure is determined to below a certain threshold, the system 12 can be configured to initiate a search and attempt to locate information about a named individual in a group that allows them to be scored or ranked or raises the confidence measure of the match to an individual in the database 206. A named individual newly scored or ranked can be added to the database 206 and their score/rank can be reported in reply to the service request, such as in 212 or 216. When a confidence measure of a match has been increased as a result of search such that it exceeds threshold value for reporting the result, then the result can be reported in a reply to the recruitment service request.

In one embodiment, when a named individual can't be located in the database 206 and information about the named individual can't be found which allows the individual to be scored or ranked, the system 12 can still be configured to keep a record of the individual. The system may keep the information so that future searches can be carried out in which attempts are made to gather information on the named individual where the gathered information can be used to develop a score or rank for the individual. Further, if the named individual shows up again as a result of a request from another entity to score the individual, then the system 12 can report that an individual may be actively looking for a job based upon the fact that the system 12 has received information about the individual from multiple entities. This information can be provided even if a score or rank is not available for the named individual.

In one embodiment, when a match is not found for a named individual in a service request and a record of the unmatched named individual is stored, the system can be configured to attempt to match the named individual at a later time. It is possible a match may be subsequently found and a score or ranking may become available for the named individual that was not previously matched. The system 12 can be configured to report the score or ranking to one or more entities that requested a score or ranking for the named individual that originally were notified that a score or ranking was not available for the individual or the confidence level of the match was below a threshold value when a score or ranking becomes subsequently available. This feature may be a system option in that a service requester can specify whether they wish to be updated or not if additional information is subsequently discovered about a named individual, such as whether a score or ranking has been developed for the name individual that was previously not available.

In general, the system can be configured to allow the recruitment service requester to specify whether or not they want updates regarding named individuals that have been previously submitted in a service request, such as 210 or 214. For example, the system can be configured to maintain a watch list for an entity including a number of named individuals in a group. In response to specified triggers, the system 12 can be configured to notify the entity. For instance, the system can notify an entity, such as recruiter, when it is determined a named individual on the watch list appears to be searching for a job. In another example, the system can be configured to notify an entity, when a score or ranking of an individual on the watch list has changed in some manner, such as exceeding some threshold value or changing by some percent amount.

The notifications from system 12 can occur through one or more different communications channels. For example, an e-mail can be sent to a recruiter. In another example, a text message can be sent to a recruiter's portable electronic device. In yet another example, an e-mail and text message can both be sent.

The system 12 can be configured to receive in a request for a recruitment service subsets of named individuals grouped in some manner The named groups may be used for comparison purposes. These different subsets are represented by the circles in FIG. 3 that are smaller than the largest circle. As described above, the largest circle can represent individuals in the developer database 206 and portions of the smaller circles lying outside of the largest circle represent named individuals in a group that have not been matched to an individual in the developer database 206.

In one example, the recruitment service request 210 for ranking/scoring of individuals can include groups 218, 220, 230 and 232. The named individuals in group 218 are possible job candidates. These candidates may have applied for a job over a first time period, such as in the last year. Group 220 may be individuals that are distinct from other members of group 218 in some manner, such as having applied for a job in the last month or having applied for a job multiple times. Group 230 can include individuals that have been offered a job. Group 232 can include individuals that have been hired.

In another example, the recruiting service request 214 can include three specified groups, 224, 226 and 228. Group 224 can be a group of individuals that have applied for jobs in between 6 months to a year ago. Group 226 can be individuals that have applied more recently for a job or jobs, such as within the last month. Group 228 can represent a current employees of a company that perform a job or jobs that are similar to the job or jobs for which the named individuals in group 228 are applying.

Scores/ranks can be provided for each individual in a group as well as for the group as whole (e.g., an average score for the named individuals in a group can be provided). The scores/ranks can be used for various comparison purposes. For example, the score of a named individual in the recent 220 group can be compared to the average score or rank of the hired individuals in group 232 or the average score or rank of the individuals that were offered jobs in group 230. Similar comparisons can also be made between individuals in groups 224, 226 and 228. For example, scores/ranks of a named individual in group 226 that has recently applied for a job can be compared to scores/ranks of individuals in group 228 or an average of scores/ranks for individuals in group 228. In another example, the average rank/scores of the individuals in group 224 that have applied 6 to 12 months ago can be compared to another group, such as individuals in group 220 that have applied for a job in the last month.

In one embodiment, this comparison feature can be used as a filter. For example, the system 12 can be configured to only return information on named individuals in a group whose score or rank is above the average of the named individuals of a comparison group. As another example, the system 12 can be configured to only return information on named individuals in a group whose score/rank is above some threshold value, such as the average score/rank of the named individuals in a group.

In the examples in FIG. 3, some of the named individuals that are submitted in different recruitment service requests can overlap. For instance, some of the named individuals in group 218 can also be named individuals in group 224. In FIG. 3, the overlap of members for groups 218 and 224 is represented by the intersections of the circle 222. In example in FIG. 3, the entity associated 202 and the entity associated with 208 may not be aware of their individual recruitment service requests and the fact one or more individuals are in each request as different entities, such as companies don't share this information. However, when a named individual is identified from multiple recruitment service requests, the system 12 can be configured to keep track of and leverage this information.

As an example, the system can be configured to record each time an individual appears in a recruitment service request. If a named individual appears multiple times over some period, it can indicate the candidate is looking for a job. If the named individual is highly ranked, this factor can be used as a trigger to notify a recruiter. For instance, as described above, a recruiter can place an individual on a watch list and request to be notified under some conditions. One of the conditions can be if the individual appears to be looking for a job which may be determined from their appearance in multiple recruitment service requests. The system 12 can be configured to allow a user to specify parameters that determine under what conditions they are to be notified.

In a recruitment service request, such as 210 or 214, a large number of names can be submitted. For example, tens of thousands of names can be submitted. The processing of a large group may take a significant amount of time. In one embodiment, the system 12 can be configured to provide results of a recruitment service request all at once. For example, the system 12 can be configured to process all of the named individuals in a recruitment service request and then return the results in a batch mode when request is completed. In another embodiment, the system 12 can be configured to send a portion of the results in real-time before the request is completed. For example, when a match is made for a named individual in a recruitment service request, the results can be returned as soon as the match has been made. As another example, when a match is made for a named individual meeting certain criteria (e.g., a ranking or score about some specified value), the results can be returned as soon as the match is made. The remaining results including or not including individual results previously sent can be returned in a batch mode when the matching process for the recruitment service request is completed.

In one embodiment, the plug-in, such as 204 or 206, can be configured to automatically submit recruitment service requests to the system 12. For example, each time an individual applies for a job and their information is entered into the ATS 202, plug-in 204 can be configured to submit a recruitment service request to system 12. When a match is found, the system 12 can return information, such as a score or ranking, about the individual. The returned information may be stored to the ATS. In another example, the recruitment service request can be triggered after some number of applicants have applied, such as after receiving 10 applications. Then, the plug-in module can send a recruitment service request including ten names to system 12. In another example, the recruitment service request from the ATS can be triggered at some time interval, such as once a day.

In the example above, one or more named individuals are described as being sent in a recruitment service request to system 12, the system 12 tries to match the named individual to an individual stored in a database, such as database 206, and then information, such as scores for matched individuals can be returned. The use of the service is described with respect to recruiting individual candidates for jobs. However, the use of the system is not limited to recruiting individual candidates for jobs.

For example, in one embodiment, the system 12 can be used to rank or score the strength of a team, such as a software development team. An employer may have a number of software development teams for different products. The individuals on each team can be submitted to system 12 and the development team can be scored. Based upon the scores, a manager may decide to reformulate the groups. For instance, some development teams have much higher scores than other development teams and a manager may reshuffle the team members such that the scores for the teams are more balanced.

In another example, a company may wish to hire a team of developers for a project. The company may receive bids from different contractors. The company can request the names of individuals that are going to be working the project for each contractor and submit their names to the recruitment enhancement system 12. The system can return scores for each of the development teams for each contractor. Based upon the scores/rankings provided for each of the team members as well as the scores as a group, the company can decide which contractor to hire for the project.

In yet another example, a company, such as a software contractor, may have their software developers ranked/scored by system 12. The system 12 can generate individual scores. The individual scores can be used to develop company scores. Then, the company may use individual scores and/or the company scores to promote the technical expertise of their employees.

As described above in response to a recruitment service request including a number of named individuals, such as 210 or 214, results which may include scores and/or ranks can be returned to the requester in 212 and or 216. An example of what information can be returned is described as follows with respect to FIG. 4B. Other types of information can be returned and the example provided in FIG. 4B is for the purposes of illustration only.

In one embodiment, the individual output data 350 can include some set of baseline information and optional information. As an example, the baseline information can include a link to a profile 352 or the information contained in a profile. The profile 352 can be a profile collated from various information sources to which system 12 has access, such as various on-line sources. The baseline information can include one or more scores, such as 354 and 356 (e.g., see description of FIG. 2 above for more details), skills possessed by the individual and an indicator 360 of the confidence measure of the match. The confidence measure can be indicated as a score, such as a numerical score, or according to some scale, such as high, medium or low.

In one embodiment, the system 12 can be configured to provide standard scores. In another embodiment, the system 12 can be configured to provide customized scores. As described above, the scores can be determined using a number of different weighting factors. The system can be configured with specifiable parameters that allow a person using the system, such as a recruiter, to influence the scores in some manner. For instance, more weight can be put on experience as opposed to some other factor, such as experience. The system 12 may allow a recruiter to vary the weights from search to search but may report for each search what weights were used.

In another example, a company may wish to develop custom scores to suit specifics of their recruitment needs. The custom scores can be utilized for all of the company's reports from the system 12. In one embodiment, a plug-in module for an ATS, described above with respect to FIG. 3, can be configured to implement custom scoring for a company such that all of the searches involving the ATS will use the custom scoring.

Returning to FIG. 4B, some examples of optional information include one or more social profile links 362, additional contact information 364 and a current job status. The formulation of the baseline information is provided for illustrative purposes only and different combinations of baseline information and optional information can be provided. Additional information that can be provided, an interface for outputting the information and example of a profile that can be returned is described in more detail in U.S. patent application Ser. No. 13/499,791, entitled RECRUITING SERVICE GRAPHICAL USER INTERFACE, previously incorporated herein by reference.

In one embodiment, the system 12 can be configured to receive parameters that allow a user to customize the information and the format of the information that is received in 350. The customization may be implemented on a request by request basis, implemented globally as part of the plug-in module or implemented on a user by user basis For example, a first user can specify one set of preferences and a second user may specify a second set of preferences for receiving information 350 where the preferences can affect the type of information that is received and its format.

In one embodiment, for a large job including information about many individuals, the system 12 can electronically send a report or a link to location that allows the report to be downloaded when the report is ready. In addition, the plug-in modules, such as 204 and 206, can be configured to add all or a portion of the information in the report to an ATS. For example, scoring results can be integrated into the ATS such that future searches involving the ATS can return scoring information without having to contact the recruitment enhancement system 12. The plug-in module can be configured to periodically communicate with the recruitment enhancement system to update the scores or ranks stored to the ATS.

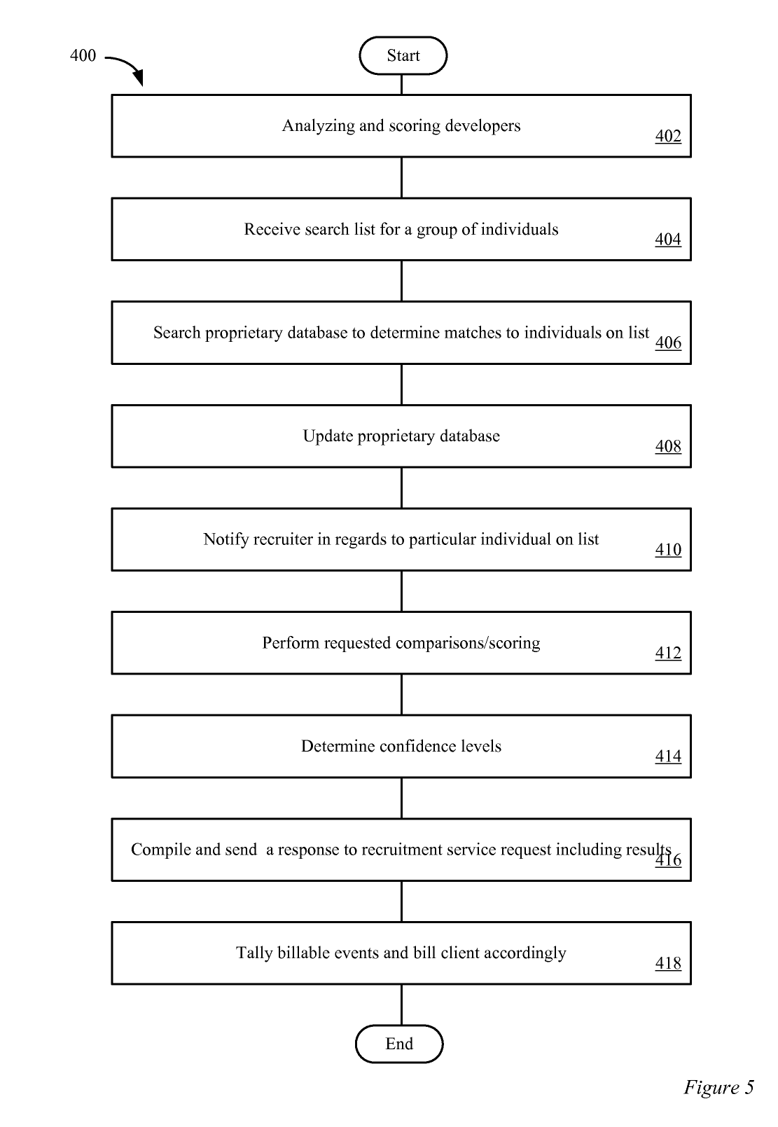

FIG. 5 is a flow chart of a method 400 of a recruitment enhancement system. In 402, the system can analyze and score developers as was described above with respect to FIG. 2. The analysis and scoring process can be an on-going activity where scores are updated with some frequency. The results from the scoring and analysis process for various individuals can be stored to a developer database, such as 206 in FIG. 3.

In 404, the system can receive a recruitment service request. The request can include information, such as a name and an e-mail address, for a number of different individuals. Different groups of individuals can be specified in the request. The specified grouping can be used for comparison purposes. For example, individuals in a first group can be compared to individuals in a second group. In 406, a search can be carried out to determine whether individuals named in the recruitment service request can be matched to individuals in a database, such as a developer database that was populated in 402. In one embodiment, the database can be a proprietary database.

In 408, in response to the recruitment service request, the database can be updated. For example, the fact that a match was determined for an individual in the database, when the match occurred and the entity requesting information about the individual can be stored. If a job description was included in the request, then information about the position can be stored. If many matches for an individual occur over some period as a result of the system receiving different recruitment service requests, the system may determine that the matched individual is looking for a job. In another example, even if a match is not found, a record can be created in the database that includes information about the individual for which a match was not found, such as their name, e-mail address and the entity the provided the information.

In 410, a notification event can be triggered. For example, a recruiter may place an individual on a watch list where if the system determines the individual is looking for a job then the recruiter is to be notified. Other parameters can be utilized to define a triggering event and the example of determining that the individual is applying for jobs is provided for illustrative purpose only. For example, another triggering event for notification can be if a score or ranking associated with the individual reaches some threshold value or changes by some amount.

In 412, the system can perform any requested comparisons and scorings, such as a team scoring or individual to group comparisons. In 414, the system can determine confidence measures for any determined matches. In one embodiment, individual results may only be reported when the confidence measure exceeds some threshold. In 416, the system can compile and send a response to the recruitment service request including the results, such as scores. For example, a report can be generated and a link to the report can be sent to a recruiter. The report can include overall statistics associated with the request, such as but not limited to a total number of matches, a total number of non-matches and an average rank/score of the matched individuals.

In 418, the system can tally billable events and bill the client accordingly. For example, in one embodiment, a billable event can be a match with a confidence level above a certain threshold. A client can be charged some amount for each match satisfying these criteria. Thus, in response to recruitment service requests involving one or more successful matches, a client can be billed according to the number of successful matches.

The various aspects, embodiments, implementations or features of the described embodiments can be used separately or in any combination. Various aspects of the described embodiments can be implemented by software, hardware or a combination of hardware and software. The computer readable medium is any data storage device that can store data which can thereafter be read by a computer system. Examples of the computer readable medium include read-only memory, random-access memory, CD-ROMs, DVDs, magnetic tape and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings.

While the embodiments have been described in terms of several particular embodiments, there are alterations, permutations, and equivalents, which fall within the scope of these general concepts. It should also be noted that there are many alternative ways of implementing the methods and apparatuses of the present embodiments. It is therefore intended that the following appended claims be interpreted as including all such alterations, permutations, and equivalents as fall within the true spirit and scope of the described embodiments.

1. A method of electronic job recruiting in a server including a processor and memory, the method comprising:
receiving in the processor information associated with professional skills of a first plurality of individuals;
for each the first plurality of individuals, generating in the processor from the received information a score wherein the score provides a qualitative indicator of an aptitude at a profession associated with the professional skills;
storing by the processor at least the score and identification information for each of the first plurality of individuals;
receiving in the processor a recruitment service request including information associated with a second plurality of individuals;
based upon the information received in the service request, determining in the processor whether each of the second plurality of individuals matches one of the first plurality of individuals; and
generating in the processor a response to the recruitment service requests that includes each of the second of plurality of individuals that are matched to one of the first plurality of individuals and the score for the matched individuals.

2. The method of claim 1, wherein the information associated with the professional skills is received from a web crawler.

3. The method of claim 1, wherein the profession is a software developer and the professional skills include software development skills.

4. The method of claim 3, wherein the information associated with the professional skills includes computer code generated by one of the first plurality of individuals and the score is at least partially based upon computer code.

5. The method of claim 1, further comprising: identifying a new individual, generating a score for the new individual and storing the new individual's identification information and score to the database.

6. The method of claim 5, further comprising: receiving new information and based upon the new information updating the score of one of the first plurality of individuals.

7. The method of claim 1, wherein the second plurality of individuals are job applicants that have recently applied for a particular job opening.

8. The method of claim 1, wherein one or more of the second plurality of individuals has previously applied for a job opening in the past that is no longer open.

9. The method of claim 1, wherein the recruitment service request is received from an applicant tracking system in electronic communication with the server.

10. The method of claim 9, wherein information associated with the second plurality of individuals is extracted from a database maintained by the applicant tracking system.

11. The method of claim 1, wherein the information associated with the second plurality of individuals includes a first name, a last name and at least one e-mail address for each individual.

12. The method of claim 11, wherein for one or more of the second plurality of individuals a plurality of e-mail addresses is included.

13. The method of claim 1, further comprising: receiving a plurality of different recruitment service requests from different entities.

14. The method of claim 13, wherein the different entities are different applicant tracking systems.

15. The method of claim 13 wherein at least one individual is common to each of the plurality of different recruitment service requests and based upon the plurality of different recruitment service requests, determining that the at least one individual is looking for a job.

16. The method of claim 15, further comprising: generating and sending a notification message to a recruiter indicating that the at least one individual is looking for a job.

17. The method of claim 1, further comprising: storing to the database information indicating an individual was included in a recruitment service request.

18. The method of claim 1, further comprising: for each of the matches, generating a confidence measure, wherein the confidence measure provides a qualitative indication of a reliability of the match.

19. The method of claim 1, further comprising: generating a group score based upon scores of the second plurality of individuals.

20. The method of claim 1, further comprising: establishing electronic communications with an applicant tracking system and sending the generated response to the applicant tracking system.

21. The method of claim 1, wherein the recruitment service request is generated in response to a search query performed using an applicant tracking system.

22. The method of claim 1, further comprising receiving information related to a third plurality of individuals in the recruitment service request and determining scores to the third plurality of individuals wherein the third plurality of individuals provide a baseline of comparison for the second plurality of individuals.

23. The method of claim 1, further comprising receiving one or more parameters in recruitment service request for generating a custom score.
